(19) United States
(12) Patent Application Publication
(10) Pub. No.: US 2004/0015888 A1
(43) Pub. Date: Jan. 22, 2004

(54) Processor system including dynamic translation facility, binary translation program that runs in computer having processor system implemented therein, and semiconductor device having processor system implemented therein

(76) Inventors: Hiroaki Fujii, Tokorozawa (JP); Yoshikazu Tanaka, Tokorozawa (JP); Yoshio Miki, Kodaira (JP)

Correspondence Address: MATTINGLY, STANGER & MALUR, P.C., 1800 DIAGONAL ROAD, SUITE 370, ALEXANDRIA, VA, 22314, US

(21) Appl. No.: 09/940,983

(22) Filed: Aug. 29, 2001

(30) Foreign Application Priority Data
Apr. 11, 2001 (JP) 2001-112354

(51) Int. Cl. G06F 9/45

(52) U.S. Cl. 717/136; 717/153

(57) ABSTRACT

An interpretation flow, a translation and optimization flow, and an original instruction prefetch flow are defined independently of one another. A processor is realized as a chip multiprocessor or realized so that one instruction execution control unit can process a plurality of processing flows simultaneously. The plurality of processing flows is processed in parallel with one another. Furthermore, within the translation and optimization flow, translated instructions are arranged to define a plurality of processing flows. Within the interpretation flow, when each instruction is interpreted, if a translated instruction corresponding to the instruction processed within the translation and optimization flow is present, the translated instruction is executed. According to the present invention, an overhead including translation and optimization that are performed in order to execute instructions oriented to an incompatible processor is minimized. At the same time, translated instructions are processed quickly, and a processor is operated at a high speed with low power consumption. Furthermore, an overhead of original instruction fetching is reduced.

### BACKGROUND OF THE INVENTION

1. Field of the Invention

The present invention relates to a processor system having a dynamic translation facility. More particularly, the present invention is concerned with a processor system that has a dynamic translation facility and that runs a binary coded program oriented to an incompatible platform while dynamically translating the program into instruction binary codes understandable by the own processor system. The present invention is also concerned with a binary translation program that runs in a computer having the processor system implemented therein, and a semiconductor device having the processor system implemented therein.

2. Description of the Related Art

Manufacturers of computer systems may adopt a microprocessor, of which architecture is different from that of conventional microprocessors, as a central processing unit of a computer system in efforts to improve the performance of the computer system.

An obstacle that must be overcome in this case is how to attain the software compatibility of the computer system having the microprocessor with other computer systems.

In principle, software usable in conventional computer systems cannot be employed in such a computer system having a modified architecture.

According to a method that has been introduced as a means for overcoming the obstacle, a source code of the software is re-complied by a compiler in the new computer system in order to produce an instruction binary code understandable by the new computer system.

If the source code is unavailable for a user of the new computer system, the user cannot utilize the above method.

A method that can be adopted even in this case is use of software. Specifically, software is used to interpret instructions that are oriented to microprocessors employed in conventional computer systems, or software is used to translate instructions oriented to the microprocessors into instructions oriented to the microprocessor employed in the new computer system so that the microprocessor can directly execute the translated instructions.

Above all, according to a method referred to as dynamic binary translation, while a software program used in a conventional computer system is running in the new computer system, the instructions constituting the software program are dynamically translated and then executed. A facility realizing the dynamic binary translation is called a dynamic translator.

The foregoing use of software is summarized in an article entitled “Welcome to the Opportunities of Binary Translation” (IEEE journal “IEEE Computer”, March 2000, P.40-P.45). Moreover, an article entitled “PA-RISC to IA-64: Transparent Execution, No Recompilation” (the same IEEE journal, P.47-P.52) introduces one case where the aforesaid technique is implemented.

The aforesaid dynamic translation technique is adaptable to a case where a microprocessor incorporated in a computer system has bee modified as mentioned above. In addition, the technique can be adapted to a case where a user who uses a computer system implemented in a certain platform wants to use software that runs in an incompatible platform.

In recent years, unprecedented microprocessors having architectures in which the dynamic translation facility is actively included have been proposed and attracted attention. In practice, a binary-translation optimized architecture (BOA) released has been introduced in “Dynamic and Transparent Binary Translation” (IEEE journal “IEEE Computer” (March 2000, P.54-P.59)). Crusoe has been introduced in “Transmeta Breaks X86 Low-Power Barrier—VLIW Chips Use Hardware-Assisted X86 Emulation” (“Microprocessor Report,” Cahners, Vol. 14, Archive 2, P.1 and P.9-P.18).

FIG. 2 shows the configuration of a feature for running a binary-coded program (composed of original instructions) oriented to an incompatible platform which includes the conventional dynamic translation facility.

Referring to FIG. 2, there is shown an interpreter 201, a controller 202, a dynamic translator 203, an emulator 204, and a platform (composed of an operating system and hardware) 205. The interpreter 201 interprets instructions that are oriented to an incompatible platform. The controller 202 controls the whole of processing to be performed by the program running feature. The dynamic translator 203 dynamically produces instructions (hereinafter may be called translated instructions) oriented to a platform, in which the program running feature is implemented, from the instructions oriented to an incompatible platform. The emulator 204 emulates special steps of the program, which involve an operating system, using a facility of the platform in which the program running feature is implemented. The program running feature is implemented in the platform 205.

When a binary-coded program oriented to an incompatible platform that is processed by the program running feature is activated in the platform 205 (including the OS and hardware), the controller 202 starts the processing. During the processing of the program, the controller 202 instructs the interpreter 201, dynamic translator 203, and emulator 204 to perform actions. The emulator 204 directly uses a facility of the platform 205 (OS and hardware) to perform an instructed action.

Next, a processing flow involving the components shown in FIG. 2 will be described in conjunction with FIG. 3.

When the program running feature shown in FIG. 2 starts up, the controller 202 starts performing actions. At step 301, an instruction included in original instructions is accessed based on an original instruction address. An execution counter indicating an execution count that is the number of times by which the instruction has been executed is incremented. The execution counter is included in a data structure contained in software such as an original instructions management table.

At step 302, the original instructions management table is referenced in order to check if a translated instruction corresponding to the instruction is present. If a translated instruction is present, the original instructions management table is referenced in order to specify a translated block 306 in a translated instructions area 308 to which the translated instruction belongs. The translated instruction is executed directly, and control is then returned to step 301. If it is found at step 302 that the translated instruction is absent, the execution count that is the number of times by which the instruction has been executed is checked. If the execution count exceeds a predetermined threshold, step 305 is activated. If the execution count is equal to or smaller than the predetermined threshold, step 304 is activated. For step 304, the controller 202 calls the interpreter 201. The interpreter 201 accesses original instructions one after another, interprets the instructions, and implements actions represented by the instructions according to a predefined software procedure.

As mentioned previously, if an instruction represents an action that is described as a special step in the program and that involves the operating system (OS), the interpreter 201 reports the fact to the controller 202. The controller 202 activates the emulator 204. The emulator 204 uses the platform 205 (OS and hardware) to perform the action. When the action described as a special step is completed, control is returned from the emulator 204 to the interpreter 201 via the controller 202. The interpreter 201 repeats the foregoing action until a branch instruction comes out as one of original instructions. Thereafter, control is returned to step 301 described as an action to be performed by the controller 202.

For step 305, the controller 202 calls the dynamic translator 203. The dynamic translator 203 translates a series of original instructions (block) that end at a branch point, at which a branch instruction is described, into instructions oriented to the platform in which the program running feature is implemented. The translated instructions are optimized if necessary, and stored as a translated block 306 in the translated instructions area 308.

Thereafter, the dynamic translator 203 returns control to the controller 202. The controller 202 directly executes the translated block 306 that is newly produced, and returns control to step 301. The controller 202 repeats the foregoing action until the program comes to an end. The aforesaid assignment of actions is a mere example. Any other assignment may be adopted.

The processing flow is realized with a single processing flow. Translation and optimization performed by the dynamic translator 203 are regarded as an overhead not included in original instructions execution, and deteriorate the efficiency in processing original instructions.

Moreover, the BOA or the Crusoe adopts a VLIW (very long instruction word) for its basic architecture, and aims to permit fast processing of translated instructions and to enable a processor to operate at a high speed with low power consumption. The fast processing of translated instructions is achieved through parallel processing of instructions of the same levels. However, the overhead that includes translation and optimization performed by the dynamic translator 203 is not reduced satisfactorily. It is therefore demanded to satisfactorily reduce the overhead. Moreover, when consideration is taken into a prospect of an LSI technology, it cannot be said that adoption of the VLIW is the best way of accomplishing the object of enabling a processor to operate at a high speed with low power consumption.

### SUMMARY OF THE INVENTION

Accordingly, an object of the present invention is to minimize an overhead that includes translation and optimization performed by the dynamic translator 203.

Another object of the present invention is to improve the efficiency in processing a program by performing prefetching of an incompatible processor-oriented program in parallel with other actions, that is, interpretation, and translation and optimization.

Still another object of the present invention is to permit fast processing of translated instructions, and enable a processor to operate at a high speed with low power consumption more effectively than the VLIW does.

In order to accomplish the above objects, according to the present invention, there is provided a processor system having a dynamic translation facility. The processor system runs a binary-coded program oriented to an incompatible platform while dynamically translating the program into instruction binary codes that are understandable by itself. At this time, a processing flow for fetching instructions, which constitute the program, one by one, and interpreting the instructions one by one using software, and a processing flow for translating each of the instructions into an instruction binary code understandable by itself if necessary, storing the instruction binary code, and optimizing the stored instruction binary code if necessary are defined independently of each other. The processing flows are implemented in parallel with each other.

Furthermore, during optimization of instruction binary codes, new instruction binary codes are arranged to define a plurality of processing flows so that iteration or procedure call can be executed in parallel with each other. Aside from the processing flow for interpretation and the processing flow for optimization, a processing flow is defined for prefetching the binary-coded program oriented to an incompatible platform into a cache memory. The processing flow is implemented in parallel with the processing flow for interpretation and the processing flow for optimization.

Moreover, the processor system includes a feature for executing optimized translated instruction binary codes. Specifically, every time optimization of an instruction binary code of a predetermined unit is completed within the processing flow for optimization, the feature exchanges the optimized instruction binary code for an instruction code that is processed within the processing flow for interpretation at the time of completion of optimization. Within the interpretation flow, when the instructions constituting the binary-coded program oriented to an incompatible platform are interpreted one by one, if an optimized translated instruction binary code corresponding to an instruction is present, the feature executes the optimized translated instruction binary code. Moreover, the processor system is implemented in a chip multiprocessor that has a plurality of microprocessors mounted on one LSI chip, or implemented so that one instruction execution control unit can process a plurality of processing flows simultaneously.

Furthermore, according to the present invention, there is provided a processor system having a dynamic translation facility and including at least one processing flow. The at least one processing flow includes a first processing flow, a second processing flow, and a third processing flow. The first processing flow is a processing flow for prefetching a plurality of instructions, which constitutes a binary-coded program to be run in incompatible hardware, and storing the instructions in a common memory. The second processing flow is a processing flow for interpreting the plurality of instructions stored in the common memory in parallel with other processing flows. The third processing flow is a processing flow for translating the plurality of instructions interpreted by the second processing flow.

Furthermore, according to the present invention, there is provided a semiconductor device having at least one microprocessor, a bus, and a common memory. The at least one microprocessor implements at least one processing flow. The at least one processing flow includes a first processing flow, a second processing flow, and a third processing flow. The first processing flow is a processing flow for sequentially prefetching a plurality of instructions, which constitutes a binary-coded program to be run in incompatible hardware, and storing the instructions in the common memory. The second processing flow is a processing flow for interpreting the plurality of instructions stored in the common memory in parallel with other processing flows. The third processing flow is a processing flow for translating the plurality of instructions interpreted by the second processing flow. The at least one microprocessor is designed to execute the plurality of instructions in parallel with one another.

Moreover, according to the present invention, there is provided a binary translation program for making a computer perform in parallel, a step for performing fetching of a plurality of instructions into the computer, a step for translating instructions, which have not been translated, among the plurality of instructions, and a step for executing the instructions through the step for translating.

### BRIEF DESCRIPTION OF THE DRAWINGS

Embodiments of the present invention are described below in conjunction with the figures, in which:

FIG. 1 is a flowchart describing a processing flow that realizes a feature for running a binary-coded program oriented to an incompatible platform which includes a dynamic translation facility and which is concerned with the present invention;

FIG. 2 shows the configuration of the feature for running a binary-coded program oriented to an incompatible platform which includes a dynamic translation facility and which is concerned with a related art;

FIG. 3 describes a processing flow that realizes the feature for running a binary-coded program oriented to an incompatible platform which includes a dynamic translation facility and which is concerned with a related art;

FIG. 4 shows the configuration of the feature for running a binary-coded program oriented to an incompatible platform which includes a dynamic translation facility and which is concerned with the present invention;

FIG. 5 shows the structure of a correspondence table that is referenced by the feature for running a binary-coded program oriented to an incompatible platform which includes a dynamic translation facility and which is concerned with the present invention;

FIG. 6 shows an example of the configuration of a chip multiprocessor in accordance with a related art;

FIG. 7 shows the correlation among processing flows in terms of a copy of original instructions existent in a cache memory which is concerned with the present invention;

FIG. 8 shows the correlation among processing flows in terms of the correspondence table residing in a main memory and a translated instructions area in the main memory which is concerned with the present invention; and

FIG. 9 shows an example of the configuration of a simultaneous multithread processor that is concerned with a related art.

### DESCRIPTION OF THE PREFERRED EMBODIMENTS

Preferred embodiments of the present invention will hereinafter be described in detail with reference to the accompanying drawings.

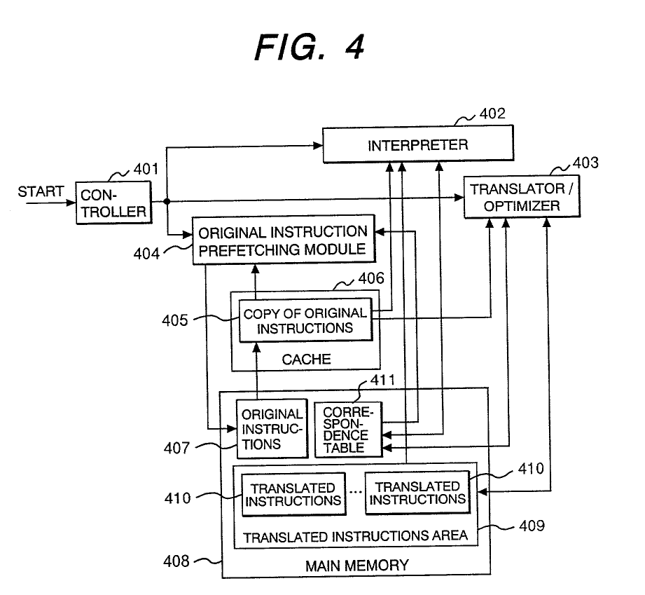

FIG. 4 shows the configuration of a feature for running a binary-coded program oriented to an incompatible platform that includes a dynamic translation facility and that is concerned with the present invention.

The program running feature consists mainly of a controller 401, an interpreter 402, a translator/optimizer 403, an original instruction prefetching module 404, original instructions 407, a translated instructions area 409, and a correspondence table 411. The original instructions 407 reside as a data structure in a main memory 408. A plurality of translated instructions 410 resides in the translated instructions area 409.

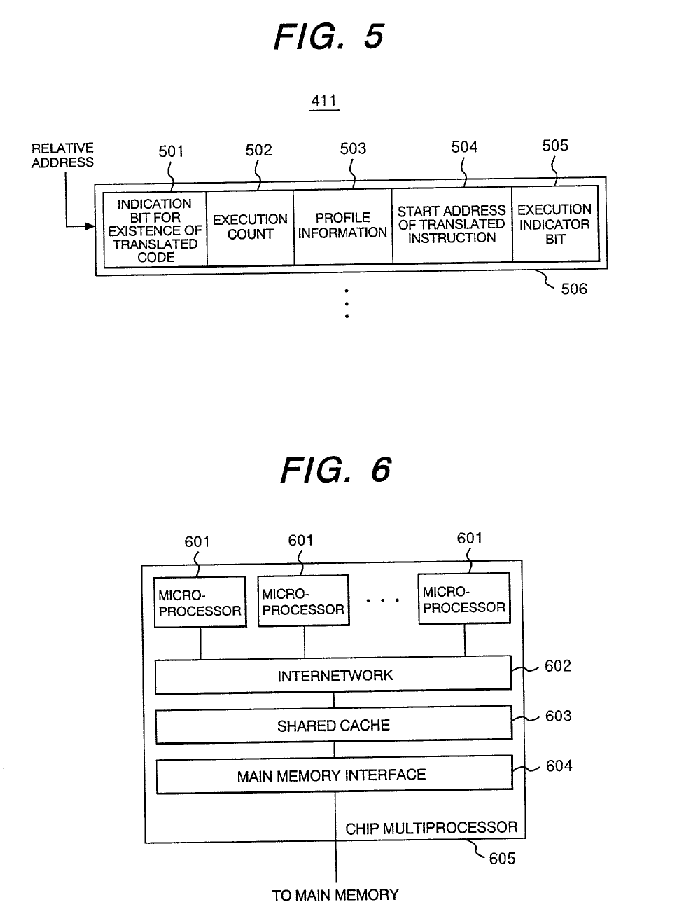

The correspondence table 411 has a structure like the one shown in FIG. 5.

Entries 506 in the correspondence table 411 are recorded in association with original instructions. Each entry is uniquely identified with a relative address that is an address of each original instruction relative to the leading original instruction among all the original instructions.

Each entry 506 consists of an indication bit for existence of translated code 501, an execution count 502, a profile information 503, a start address of translated instruction 504, and an execution indicator bit 505.

The indication bit for existence of translated code 501 indicates whether a translated instruction 410 corresponding to an original instruction specified with the entry 506 is present. If the indication bit for existence of translated code 501 indicates that the translated instruction 410 corresponding to the original instruction specified with the entry 506 is present (for example, the indication bit is 1), the start address of translated instruction 504 indicates the start address of the translated instruction 410 in the main memory 408.

In contrast, if the indication bit for existence of translated code 501 indicates that the translated instruction 410 corresponding to the original instruction specified with the entry 506 is absent (for example, if the indication bit is 0), the start address of translated instruction 504 is invalid.

Moreover, the execution count 502 indicates the number of times by which the original instruction specified with the entry 506 has been executed. If the execution count 502 exceeds a predetermined threshold, the original instruction specified with the entry 506 is an object of translation and optimization that is processed by the translator/optimizer 403.

Furthermore, the profile information 503 represents an event that occurs during execution of the original instruction specified with the entry 506 and that is recorded as a profile.

For example, if an original instruction is a branch instruction, information concerning whether the condition for a branch is met or not is recorded as the profile information 503. Moreover, profile information useful for translation and optimization that is performed by the translator/optimizer 403 is also recorded as the profile information 503. The execution indicator bit 505 assumes a specific value (for example, 1) to indicate that a translated instruction 410 corresponding to the original instruction specified with the entry 506 is present or that the interpreter 402 is executing the translated instruction 410.

In any other case, the execution indicator bit 505 assumes an invalid value (for example, 0). The initial values of the indication bit for existence of translated code 501 and execution indicator bit 505 are the invalid values (for example, 0). The initial value of the execution count 502 is 0, and the initial value of the profile information 503 is an invalid value.

Referring back to FIG. 4, the actions to be performed by the components will be described below.

When a binary-coded program oriented to an incompatible platform is started to run, the controller 401 defines three independent processing flows and assigns them to the interpreter 402, translator/optimizer 403, and original instruction prefetching module 404 respectively.

The processing flow assigned to the original instruction prefetching module 404 is a flow for prefetching original instructions 407 to be executed.

The prefetched original instructions reside as a copy 405 of original instructions in a cache memory 406. When the interpreter 402 and translator/optimizer 403 must access the original instructions 407, they should merely access the copy 405 of the original instructions residing in the cache memory 406.

If an original instruction prefetched by the original instruction prefetching module 404 is a branch instruction, the original instruction prefetching module 404 prefetches a certain number of instructions from one branch destination and a certain number of instructions from the other branch destination. The original instruction prefetching module 404 then waits until the branch instruction is processed by the interpreter 402. After the processing is completed, the correspondence table 411 is referenced in order to retrieve the profile information 503 concerning the branch instruction. A correct branch destination is thus identified, and original instructions are kept prefetched from the branch destination.

The processing flow assigned to the interpreter 402 is a flow for interpreting each of original instructions or a flow for directly executing a translated instruction 410 corresponding to an original instruction if the translated instruction 410 is present. Whether an original instruction is interpreted or a translated instruction 410 corresponding to the original instruction is directly executed is judged by checking the indication bit for existence of translated code 501 recorded in the correspondence table 411.

If the indication bit for existence of translated code 501 concerning the original instruction indicates that a translated instruction 410 corresponding to the original instruction is absent (for example, the bit is 0), the interpreter 402 interprets the original instruction.

In contrast, if the indication bit for existence of translated code 501 indicates that the translated instruction 410 corresponding to the original instruction is present (for example, the bit is 1), the interpreter 402 identifies the translated instruction 410 corresponding to the original instruction according to the start address of translated instruction 504 concerning the original instruction. The interpreter 402 then directly executes the translated instruction 410.

At this time, the interpreter 402 validates the execution indicator bit 505 concerning the original instruction before directly executing the translated instruction 410 (for example, the interpreter 402 sets the bit 505 to 1). After the direct execution of the translated instructions 410 is completed, the execution indicator bit 505 is invalidated (for example, reset to 0).

Moreover, every time the interpreter 402 interprets an original instruction or executes a translated instruction corresponding to the original instruction, the interpreter 402 writes the number of times, by which the original instruction has been executed, as the execution count 502 concerning the original instruction. Moreover, profile information is written as the profile information 503 concerning the original instruction.

The processing flow assigned to the translator/optimizer 403 is a flow for translating an original instruction into an instruction understandable by itself, and optimizing the translated instruction.

The translator/optimizer 403 references the correspondence table 411 to check the execution count 502 concerning an original instruction. If the execution count 502 exceeds a predetermined threshold, the original instruction is translated into an instruction understandable by itself. The translated instruction 410 is stored in the translated instructions area 409 in the main memory 408. If translated instructions corresponding to preceding and succeeding original instructions are present, the translated instructions including the translated instructions corresponding to the preceding and succeeding original instructions are optimized to produce new optimized translated instructions 410.

For optimization, the correspondence table 411 is referenced to check the profile information items 503 concerning the original instructions including the preceding and succeeding original instructions. The profile information items are used as hints for the optimization.

The translator/optimizer 403 having produced a translated instruction 410 references the correspondence table 411 to check the indication bit for existence of translated code 501 concerning an original instruction. If the indication bit for existence of translated code 501 is invalidated (for example, 0), the indication bit 501 is validated (for example, set to 1). The start address of the translated instruction 410 in the main memory 408 is written as the start address of translated instruction 504 concerning the original instruction.

In contrast, if the indication bit for existence of translated code 501 is validated (for example, 1), the execution indicator bit 505 concerning the original instruction is checked. If the execution indicator bit 505 is invalidated (for example, 0), the memory area allocated to the former translated instruction 410, which is pointed by the start address of translated instruction 504, is released. The start address of the new translated instruction 410 in the main memory 408 is then written as the start address of translated instruction 504 concerning the original instruction.

At this time, if the execution indicator bit 505 is validated (for example, 1), it is waited until the execution indicator bit 505 is invalidated (for example, reset to 0). The memory area allocated to the former translated instruction 410, which is pointed by the start address of translated instruction 504 concerning the original instruction, is then released. The start address of the new translated instruction 410 in the main memory 408 is then written as the start address of translated instruction 504 concerning the original instruction.

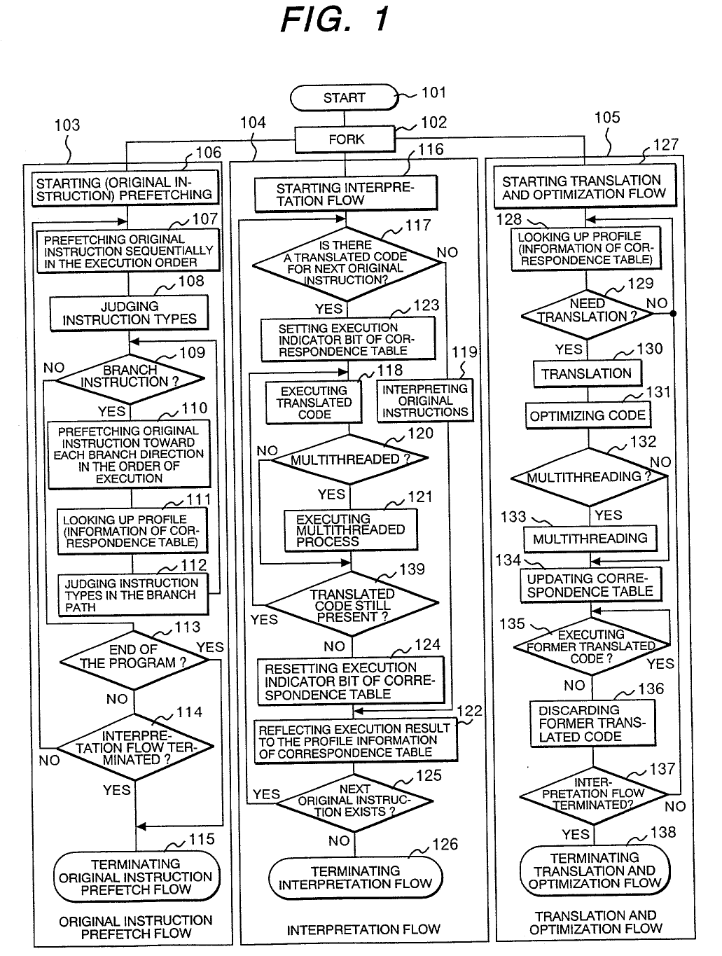

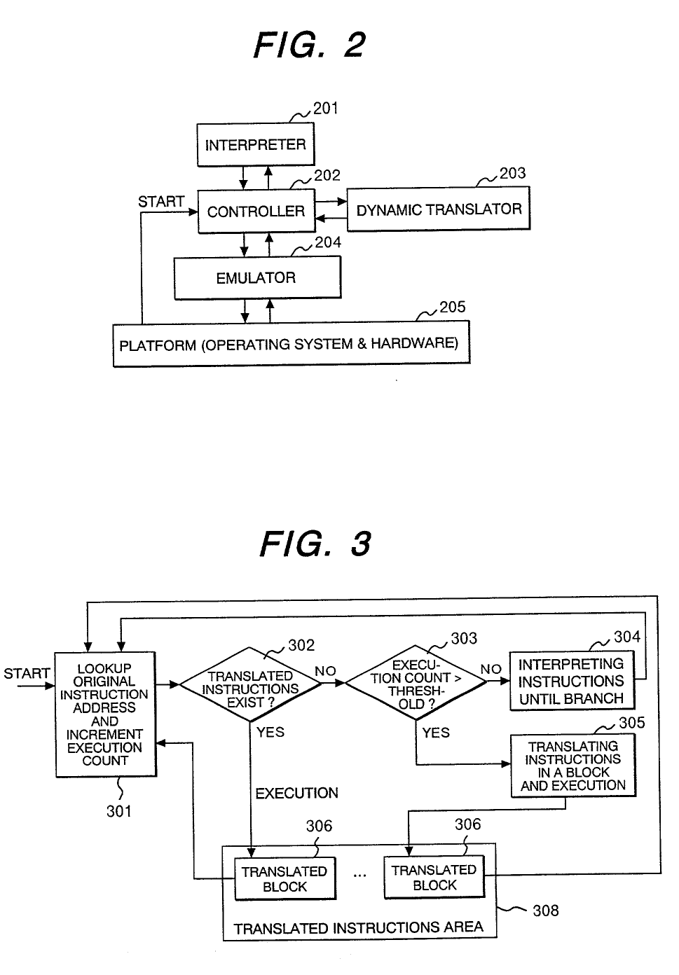

Next, a processing flow that realizes the feature for running a binary-coded program oriented to an incompatible platform which is concerned with the present invention and which includes a dynamic translation facility will be described in conjunction with FIG. 1.

At step 101, the dynamic translator starts running a binary-coded program oriented to an incompatible platform. At step 102, the processing flow is split into three processing flows.

The three processing flows, that is, an original instruction prefetch flow 103, an interpretation flow 104, and a translation and optimization flow 105 are processed in parallel with one another.

The processing flows will be described one by one below. To begin with, the original instruction prefetch flow 103 will be described. The original instruction prefetch flow is started at step 106.

At step 107, original instructions are prefetched in order of execution. At step 108, the types of prefetched original instructions are decoded. It is judged at step 109 whether each original instruction is a branch instruction. If so, control is passed to step 110. Otherwise, control is passed to step 113. At step 110, original instructions are prefetched in order of execution from both branch destinations to which a branch is made as instructed by the branch instruction.

At step 111, the correspondence table 411 is referenced to check the profile information 503 concerning the branch instruction. A correct branch destination is thus identified. At step 112, the types of original instructions prefetched from the correct branch destination path are decoded. Control is then returned to step 109, and the step 109 and subsequent steps are repeated.

At step 113, it is judged whether an area from which an original instruction should be prefetched next lies outside an area allocated to the program consisting of the original instructions. If the area lies outside the allocated area, control is passed to step 115. The original instruction prefetch flow is then terminated. If the area does not lie outside the allocated area, control is passed to step 114. At step 114, it is judged whether the interpretation flow 104 is terminated. If the interpretation flow 104 is terminated, control is passed to step 115. The original instruction prefetch flow is then terminated. If the interpretation flow 104 is not terminated, control is passed to step 107. The step 107 and subsequent steps are then repeated.

Next, the interpretation flow 104 will be described below. The interpretation flow 104 is started at step 116.

At step 117, the correspondence table 411 is referenced to check the indication bit for existence of translated code 501 concerning a subsequent original instruction that comes next in order of execution (or the first original instruction). Whether a translated instruction 410 corresponding to the original instruction is present is thus judged. If the translated instruction 410 corresponding to the original instruction is present, control is passed to step 123. Otherwise, control is passed to step 119. At step 119, the original instruction is interpreted. Control is then passed to step 122. At step 123, prior to execution of the translated instruction 410, the execution indicator bit 505 concerning the original instruction recorded in the correspondence table 411 is set to a value indicating that execution of the translated instruction 410 is under way (for example, 1).

At step 118, direct execution of the translated instruction 410 is started. During the direct execution, if multithreading is instructed to start at step 120, the multithreading is performed at step 121. If all translated instructions 410 have been executed, it is judged at step 139 that the direct execution is completed. Control is then passed to step 124. At step 124, the execution indicator bit 505 concerning the original instruction recorded in the correspondence table 411 is reset to a value indicating that execution of the translated instruction 410 is not under way (for example, to 0).

At step 122, the results of processing an original instruction are reflected in the execution count 502 and profile information 503 concerning the original instruction recorded in the correspondence table 411. At step 125, it is judged whether the next original instruction is present. If not, control is passed to step 126. The interpretation flow is terminated. If the next original instruction is present, control is returned to step 117. The step 117 and subsequent steps are then repeated.

Next, the translation and optimization flow 105 will be described below. The translation and optimization flow is started at step 127.

At step 128, the correspondence table 411 is referenced to sequentially check the execution counts 502 and profile information items 503. At step 129, it is judged whether each execution count 502 exceeds the predetermined threshold. If the execution count 502 exceeds the predetermined threshold, control is passed to step 130. If not, control is returned to step 128.

At step 130, the original instruction specified with the entry 506 of the correspondence table 411, that contains the execution count 502 which exceeds the predetermined threshold, is translated. The translated instruction 410 is then stored in the translated instructions area in the main memory 408.

When the translated instruction 410 is generated, the profile information item 503 concerning the original instruction recorded in the correspondence table 411 is used as information needed to optimize it.

At step 131, if translated instructions 410 corresponding to original instructions preceding and succeeding the original instruction are present, the translated instructions including the translated instructions corresponding to the preceding and succeeding original instructions are optimized again.

During optimization, if it is judged at step 132 that multithreading would improve the efficiency in processing the program, multithreading is performed at step 133.

At step 134, the indication bit for existence of translated code 501 concerning the original instruction recorded in the correspondence table 411 is set to a value indicating that a translated instruction 410 corresponding to the original instruction is present (for example, 1). Furthermore, the start address of the translated instruction 410 in the main memory 408 is written as the start address of translated instruction 504 in the entry 506.

At step 135, the correspondence table 411 is referenced to check the execution indicator bit 505 concerning the original instruction. It is then judged whether execution of an old translated instruction corresponding to the original instruction is under way.

If the execution is under way, it is waited until the execution is completed. Otherwise, the memory area allocated to the former translated instruction 410 is released and discarded at step 136.

At step 137, it is judged whether the interpretation flow is terminated. If so, control is passed to step 138, and the translation and optimization flow is terminated. If the interpretation flow is not terminated, control is returned to step 128, and the step 128 and subsequent steps are repeated.

The processing flow that realizes the feature for running a binary-coded program oriented to an incompatible platform which includes a dynamic translation facility and which is concerned with the present invention has been described so far.

Now, what is referred to as optimization is processing intended to speed up execution of a run-time code produced from an instruction code that is treated by a compiler or any other software which re-sorts translated instructions and reduces the number of translated instructions.

Furthermore, what is referred to multithreading is processing intended to improve the efficiency in processing a program by concurrently executing instructions in parallel with one another using microprocessors. Incidentally, conventionally, instructions constituting a program are executed sequentially.

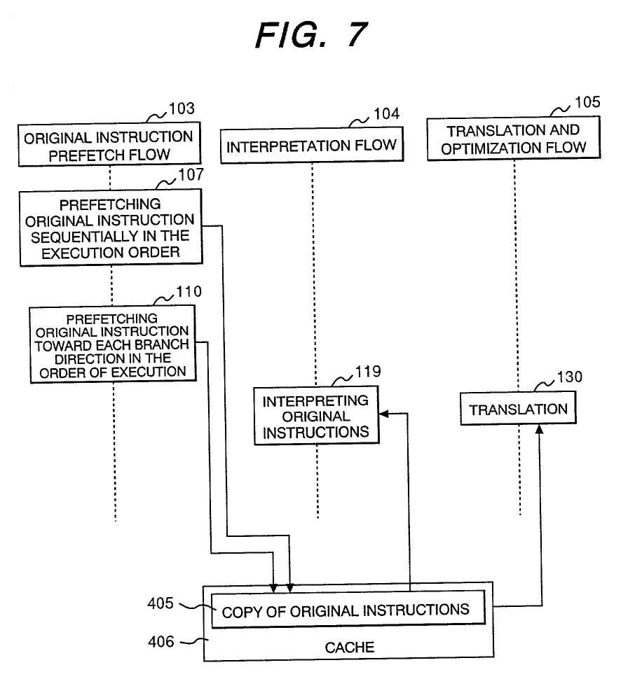

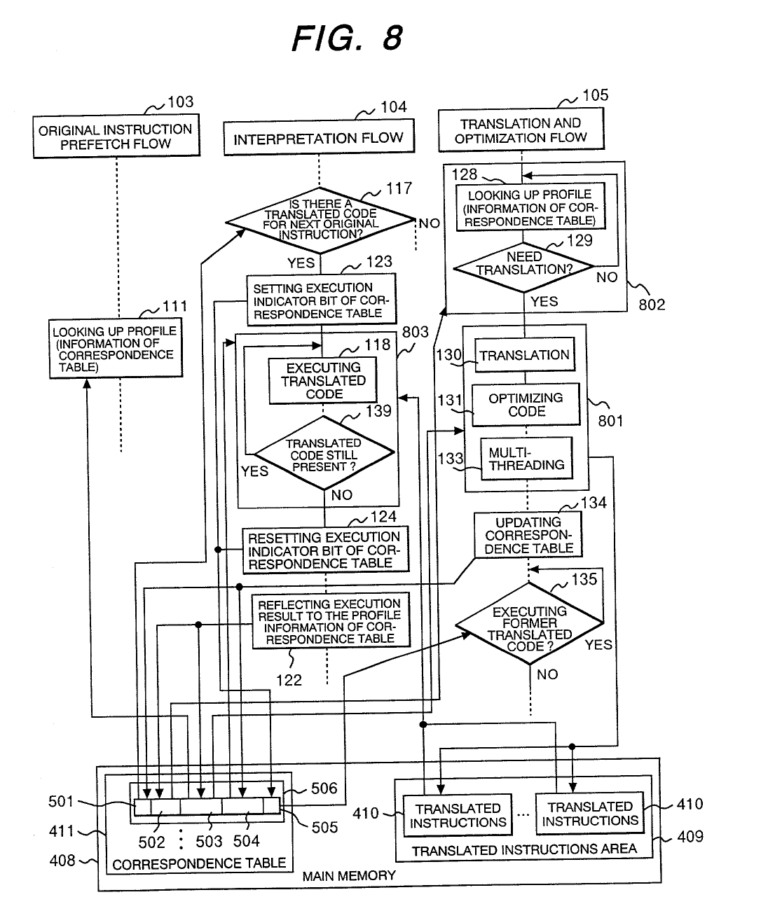

Referring to FIG. 7 and FIG. 8, the correlation among the original instruction prefetch flow 103, interpretation flow 104, and translation and optimization flow 105 will be described in terms of access to a common data structure.

FIG. 7 shows the correlation among the processing flows in terms of access to the copy 405 of original instructions residing in the cache memory 406. The copy 405 of original instructions is produced and stored in the cache memory 406 through original instruction prefetching performed at steps 107 and 110 within the original instruction prefetch flow 103. The copy of original instructions 405 is accessed when an original instruction must be fetched at step 119 within the interpretation flow 104 or step 130 within the translation and optimization flow 105.

FIG. 8 shows the correlation among the processing flows in terms of access to the items of each entry 506 recorded in the correspondence table 411 stored in the main memory 408 or access to translated instructions 410 stored in the translated instruction area 409 in the main memory 408. The items of each entry 506 are the indication bit for existence of translated code 501, execution count 502, profile information 503, start address of translated instruction 504, and execution indicator bit 505.

First, the indication bit for existence of translated code 501 is updated at step 134 within the translation and optimization flow 105, and referred at step 117 within the interpretation flow 104.

Next, the execution count 502 is updated at step 122 within the interpretation flow 104, and referred at steps 802 that start at step 128 within the translation and optimization flow 105 and end at step 129. The profile information 503 is updated at step 122 within the interpretation flow 104, and referred at step 111 within the original instruction prefetch flow 103 and steps 801 that start at step 130 within the translation and optimization flow 105 and end at step 133.

The start address of translated instruction 504 is updated at step 134 within the translation and optimization flow 105, and referred at steps 803 that start at step 118 within the interpretation flow 104 and end at step 139.

The execution indicator bit 505 is updated at step 123 and step 124 within the interpretation flow 104, and referred at step 135 within the translation and optimization flow 105.

Finally, the translated instructions 410 are generated at steps 801 that start at step 130 within the translation and optimization flow 105 and end at step 133, and referred at steps 803 that start at step 118 within the interpretation flow 104 and end at step 139.

A translated instruction being processed within the interpretation flow 104 is exchanged for a new translated instruction produced by optimizing a translated instruction within the translation and optimization flow 105. At this time, exclusive control is extended (that is, when a common memory in the main memory is utilized within both the processing flows 104 and 105, while the common memory is used within one of the processing flows, it is disabled to use the common memory within the other processing flow).

The processing method presented by the feature for running a binary-coded program oriented to an incompatible platform which includes a dynamic translation facility and which is concerned with the present instruction has been described so far.

Now, a platform in which the above processing can be performed will be described below.

FIG. 6 shows an example of the configuration of a chip multiprocessor 605.

A concrete example of the platform has been revealed in a thesis entitled “Data Speculation Support for a Chip Multiprocessor” (proceedings of the Eighth International Conference on Architectural Support for Programming Languages and Operating Systems (ASPLOS VIII) P.58-P.69).

The chip multiprocessor 605 consists mainly of a plurality of microprocessors 601, an internet work 602, a shared cache 603, and a main memory interface 604. The microprocessors 601 are interconnected over the internetwork 602. The shared cache 603 is shared by the plurality of microprocessors 601 and connected on the internetwork 602.

A plurality of processing flows defined according to the processing method in accordance with the present invention are referred to as threads. The threads are assigned to the plurality of microprocessors 601 included in the chip multiprocessor 605. Consequently, the plurality of processing flows is processed in parallel with each other.

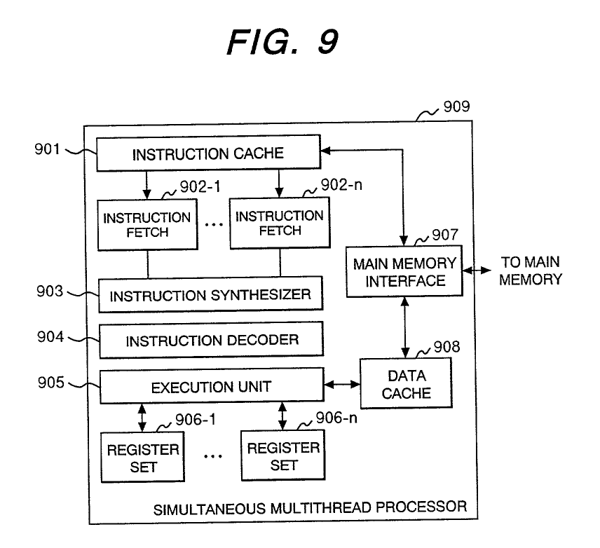

FIG. 9 shows an example of the configuration of a simultaneous multithread processor 909.

A concrete example of the platform has been introduced in a thesis entitled “Simultaneous Multithreading: A Platform for Next-Generation Processors” (IEEE Micro, September October 1997, P.12-P.19).

The simultaneous multithread processor 909 consists mainly of an instruction cache 901, a plurality of instruction fetch units 902 (instruction fetch units 902-1 to 902-n), an instruction synthesizer 903, an instruction decoder 904, an execution unit 905, a plurality of register sets 906 (register sets 906-1 to 906-n), a main memory interface 907, and a data cache 908.

Among the above components, the instruction cache 901, instruction decoder 904, execution unit 905, main memory interface 907, and data caches 908 are basically identical to those employed in an ordinary microprocessor.

The characteristic components of the simultaneous multithread processor 909 are the plurality of instruction fetch units 902 (instruction fetch units 902-1 to 902-n), instruction synthesizer 903, and plurality of register sets 906 (register sets 906-1 to 906-n). The plurality of instruction fetch units 902 (instruction fetch units 902-1 to 902-n) and plurality of register sets 906 (register sets 906-1 to 906-n) are associated with the threads that are concurrently processed by the simultaneous multithread processor 909 in accordance with the present invention.

The instruction synthesizer 903 restricts the instruction fetch units 902 each of which fetches an instruction according to the processing situation of each thread at any time instant. The instruction synthesizer 903 selects a plurality of instructions, which can be executed concurrently, from among candidates for executable instructions fetched by the restricted instruction fetch units 902, and hands the selected instructions to the instruction decoder 904.

The plurality of processing flows defined according to the processing method in accordance with the present invention are assigned as threads to the instruction fetch units 902 (instruction fetch units 902-1 to 902-n) and register sets 906 (register sets 906-1 to 906-n). Consequently, the plurality of processing flows is processed in parallel with one another.

The embodiment of the present invention has been described so far.

According to the present invention, when an incompatible processor-oriented program is run while instructions constituting the program are translated into instructions understandable by an own processor system, an overhead including translation and optimization can be minimized.

Furthermore, since prefetching of instructions constituting the incompatible processor-oriented program is executed in parallel with interpretation, and translation and optimization, the efficiency in processing the program is improved.

Moreover, in particular, when the processing method in accordance with the present invention is adopted in conjunction with a chip multiprocessor, translated instructions can be executed fast, and processors can be operated at a high speed with low power consumption.

What is claimed is:

1. A processor system that includes a dynamic translation facility and that runs a binary-coded program oriented to an incompatible platform while dynamically translating instructions, which constitute the program, into instruction binary codes understandable by itself, comprising:
a processing flow for fetching the instructions, which constitute the binary-coded program oriented to an incompatible platform, one by one, and interpreting the instructions one by one using software; and
a processing flow for translating respective of the instructions into an instruction binary code understandable by itself when necessary, storing the instruction binary code, and optimizing the instruction binary code being stored when necessary,
wherein:
the processing flow for interpreting the instructions and the processing flow for translating are independent and processed in parallel with each other.

2. A processor system according to claim 1, wherein:
during optimization of respective instruction binary code, new instruction binary codes are arranged to produce a plurality of processing flows so that iteration or procedure call can be executed in parallel with each other.

3. A processor system according to claim 1, wherein:
a processing flow for prefetching the binary-coded program oriented to the incompatible platform into a cache memory is defined separately from the processing flow for interpreting and the processing flow for translating and optimizing; and
the processing flow for prefetching is processed in parallel with the processing flow for interpreting and the processing flow for translating and optimizing.

4. A processor system according to claim 1, wherein:
every time translation and optimization of an instruction binary code of a predetermined unit is completed within the processing flow for translating and optimizing, the optimized and translated instruction binary code is exchanged for an instruction code that is processed within the processing flow for interpreting at the time of completion of optimization; and
when the instructions constituting the binary-coded program oriented to the incompatible platform are being interpreted one by one within the processing flow for interpreting, in case that an optimized translated instruction binary code corresponding to one instruction is present, the optimized translated instruction binary code is executed.

5. A processor system according to claim 1, wherein the processor system is implemented in a chip multiprocessor that has a plurality of microprocessors mounted on one LSI chip, and the different microprocessors process the plurality of processing flows in parallel with one another.

6. A processor system according to claim 1, wherein one instruction execution control unit processes a plurality of processing flows concurrently, and the plurality of processing flows are processed in parallel with one another.

7. A processor system according to claim 1, wherein when a translated instruction being processed within the processing flow for interpreting is exchanged for a new translated instruction produced by optimizing the translated instruction within the processing flow for translating and optimizing, an exclusive control is performed.

8. A processor system including a dynamic translation facility and including at least one processing flow, wherein:
the at least one processing flow includes a first processing flow for sequentially prefetching a plurality of instructions, which constitute a binary-coded program to be run in incompatible hardware, and storing the instructions in a common memory, a second processing flow for concurrently interpreting the plurality of instructions stored in the common memory in parallel with one another, and a third processing flow for translating the plurality of interpreted instructions.

9. A processor system according to claim 8, wherein the second processing flow executes the translated code when the instruction of the plurality of instructions have already been translated and interprets the instruction when it has not been translated.

10. A processor system according to claim 8, wherein within the third processing flow, among the plurality of instructions, instructions that have not been translated are translated, and the translated instructions are re-sorted or the number of translated instructions is decreased.

11. A processor system according to claim 8, wherein the first processing flow, the second processing flow, and the third processing flow are processed independently in parallel with one another.

12. A semiconductor device having at least one microprocessor, a bus, and a common memory, including:
the at least one microprocessor composed of processing at least one processing flow;
the at least one processing flow including:
a first processing flow for sequentially prefetching a plurality of instructions that constitute a binary-coded program to be run in incompatible hardware, and storing the instructions in the common memory,
a second processing flow for concurrently interpreting the plurality of instructions stored in the common memory in parallel with one another, and
a third processing flow for translating the plurality of interpreted instructions,
wherein:
the at least one microprocessor is composed of implementing the plurality of instructions in parallel with one another.

13. A binary translation program for making a computer perform in parallel:
a step for performing fetching of a plurality of instructions into the computer;
a step for translating instructions, which have not been translated, among the plurality of instructions; and
a step for executing the instructions through the step for translating.
